(19) United States
(12) Patent Application Publication
(10) Pub. No.: US 2012/0044988 A1
(43) Pub. Date: Feb. 23, 2012

(54) FAST ALGORITHM ADAPTIVE INTERPOLATION FILTER (AIF)

(75) Inventors: Cheung Auyeung, Sunnyvale, CA (US); Ali Tabatabai, Cupertino, CA (US)

(73) Assignee: SONY CORPORATION, Tokyo (JP)

(21) Appl. No.: 12/859,070

(22) Filed: Aug. 18, 2010

(51) Int. Cl. H04N 7/12

(52) U.S. Cl. 375/240.03; 375/E07.076

(57) ABSTRACT

An apparatus and method are taught for estimating an optimized sub-pixel interpolation filter using iterative and non-iterative estimations as needed for sub-pixel motion compensation and motion estimation in a video codec for improving coding efficiency. Motion vector information and mode decisions are passed from the first encoding stage which uses predetermined interpolation to at least a second encoding stage which uses an estimated adaptive interpolation filter determined during the first encoding stage. Processing overhead is reduced within the subsequent stages. Embodiments are described in which additional stages perform iterative encoding and estimation of interpolation filter in an n-th iteration.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to image encoding, and more particularly to computation of a fast adaptive interpolation filter.

2. Description of Related Art

Numerous forms and variations of video coding are available today for encoding video so that it is more compact for storage and transmission. A video codec encodes a sequence of video frames which each have a plurality of pixels having corresponding pixel values. The encoding process generally refers to converting pixel values of a frame according to one or more encoding approaches into an output bit stream which can be received separately in time and/or space for decoding into frames which closely approximate the original frames to an acceptable error level.

In predictive encoding, elements of a frame are predicted based on prior decoded frames and a difference signal is generated between predicted and original frames. The difference may be further compressed and sent as an encoded signal. The decoder similarly performs prediction toward reducing data transfer between the encoder and the decoder, and adds the difference signals to decode the video signal and recreate the original frames to a desired or sufficient degree of accuracy.

Additional levels of compression can be achieved in response to motion compensation in which blocks of one frame can be utilized to predict blocks in other frames and locations thereof, to increase compression. The prediction comprises a displacement referred to as a motion vector. Motion vectors are often specified in terms of pixel positions, and can even predict movement to the granularity of sub-pixels. Sub-pixel motion estimations require that the image frame also be generated at sub-pixel granularity, even though the image sensor hardware itself may only generate a single pixel for each pixel position.

The use of sub-pixel motion estimation requires that additional sub-pixel values be generated from the source pixels, such as within an interpolation process which is often used for generating sub-pixel values. Interpolation generally entails processing pixel values surrounding a given pixel and interpolating characteristics from which the sub-pixels are estimated. The default level of resolution for motion estimation under MPEG-4 is typically a half pixel (Hpel) (where “pel”=picture element=pixel), while quarter pixel (Qpel), and other resolutions can be supported.

Various interpolation filters are often utilized to perform motion estimation and compensation of sub-pixel values (fractional pel resolution). In one approach, a horizontal or vertical 6-tap Wiener interpolation filter is first used to calculate half-pel positions, then another filter applied, such as a bilinear filter, to obtain quarter-pel positions. An adaptive interpolation filter approach has also been proposed in which the filter is independently estimated for each image, to take into account the alteration of image signal properties, in particular aliasing, toward minimizing predictive error energy. Displacement vectors estimated in a first iteration are then used in further iterations using other interpolation filters.

Toward improving video encoding, the fixed encoding of AVC was, for example, replaced in the KTA 1.8 standard with the ability to dynamically change the interpolation filter as seen in FIG. 1. The KTA 1.8 codec estimates the filter coefficients in a fixed two-pass algorithm, in which it uses a pre-determined (fixed) interpolation filter, and then estimates an adaptive interpolation filter based on the motion vectors from the fixed interpolation. In contrast to a fixed filter, the adaptive filter is adaptive by virtue of its ability to change from frame to frame as the video sequence progresses.

In particular, in the first pass, the interpolation filter from AVC is used to compress the current picture and to estimate the optimal interpolation filter based on the current sub-pixel motion vectors. In the second pass, the estimated adaptive interpolation filter from the first pass is used to replace the AVC interpolation filter to compress the current picture again. Then the KTA 1.8 decides whether the coded representation of the picture in the first pass or the second pass should be selected as the final representation of the picture. In this fixed two pass algorithm, the adaptive interpolation filter is intended to improve the AVC interpolation filter to increase coding efficiency.

A reduction of the computational overhead has been attempted by others based on estimating the interpolation filter from the previously encoded picture and applying the interpolation filter to the current picture to keep the computation down to 1×. However, this approach results in lower coding efficiency than the two pass algorithm.

Accordingly, a need exists for mechanisms for implementing fast adaptive interpolation filters which provide high coding efficiency and are readily determined. The present invention fulfills that need and is particularly well-suited for increasing coding efficiency within a codec following advanced video coding standards, such as AVC.

### BRIEF SUMMARY OF THE INVENTION

The present invention teaches fast adaptive interpolation filters (AIF), which provide different trade offs between computation and coding efficiency. In one implementation, the computation of integer motion estimation is avoided in the second pass. In another implementation, additional computation is circumvented by avoiding integer motion estimation and other mode decisions in the second pass.

This invention provides different trade-off levels between computation and coding efficiency of a two pass AIF method by passing encoding information, such as motion vectors and mode decisions, from one pass to the next pass to reduce the computation of the second pass. In the case that only integer pel motion vectors are passed from the first pass to the second pass, the second pass is configured to reuse the integer pel motion vectors and skip the integer pel motion estimation completely or partially to reduce computation. In the case that mode decisions are also passed from the first pass to the second pass, the second pass can reuse those mode decisions to reduce or eliminate the computation needed for mode decisions, and therefore it significantly reduces the computation of the second pass.

Preferably, in at least one embodiment, the number of iteration passes can be determined in response to a predetermined number of passes, or selected in response to information obtained during training or in response to other inputs. The number of iterations is generally controlled by how fast convergence can take place in the optimization process.

The invention is amenable to being embodied in a number of ways, including but not limited to the following descriptions.

One embodiment of the invention is an apparatus for optimizing encoding in a video codec, comprising: (a) a computer configured for receiving a video having a plurality of pictures; (b) a memory coupled to the computer; and (c) programming configured for retention in the memory and executable on the computer for, (c)(i) performing a first pass encoding (e.g., comprises a transform, a quantization, an inverse quantization, and an inverse transform) of a current picture within the plurality of pictures within the video in response to executing transforms, (c)(ii) quantization and applying a predetermined interpolation filter (e.g., defined in response to a set of filter coefficients) optimized for sub-pixel motion vectors, (c)(iii) performing a first pass estimation of an adaptive interpolation filter (e.g., defined in response to a set of filter coefficients) optimized for pixel and sub-pixel motion vectors to create a first pass encoded representation, (c)(iv) communicating motion vectors, mode decisions and first estimation of an adaptive interpolation filter from the first pass estimation for subsequent encoding, (c)(v) performing at least a second encoding (e.g., comprises a transform, a quantization, an inverse quantization, and an inverse transform) of the current picture, in response to the first estimation of adaptive interpolation filter and using the motion vector and mode decisions, to generate a final pass encoded representation, (c)(vi) selecting either the first pass encoded representation or the final pass encoded representation as an optimally efficient encoded representation for the current picture, and (c)(vii) outputting an encoded video stream of the optimally efficient encoded representation.

In at least one implementation the programming executable on the computer is configured for compressing and embedding the set of filter coefficients within the encoded video stream. In at least one implementation motion vectors and mode decisions are generated from the first pass encoding. In at least one implementation the apparatus is configured for dynamically changing the interpolation filter on a picture-by-picture basis as the video is encoded.

In at least one implementation additional programming is configured for performing iterative encoding and estimation of interpolation filter in an n-th iteration optimized for sub-pixel motion vectors determined in the n-th iteration within the at least a second encoding; and wherein the final pass encoded representation is generated in response to an n+1th iteration pass. In at least one implementation the programming determines if the n-th iteration is the last iteration prior to encoding the current picture again. In at least one implementation, n of the n-th iteration is compared against a threshold value N to determine if the n-th iteration is the last iteration prior to encoding the current picture again.

One embodiment of the invention is an apparatus for optimizing encoding in a video codec, comprising: (a) a computer configured for receiving a video having a plurality of pictures; (b) a memory coupled to the computer; and (c) programming configured for retention in the memory and executable on the computer for, (c)(i) performing a first pass encoding of a current picture within the plurality of pictures within the video in response to executing transforms, quantization and applying a predetermined interpolation filter optimized for sub-pixel motion vectors, (c)(ii) performing a first estimation of an adaptive interpolation filter optimized for pixel and sub-pixel motion vectors to create a first pass encoded representation, (c)(iii) communicating motion vectors, mode decisions and first estimation of an adaptive interpolation filter from the first pass estimation for subsequent encoding, (c)(iv) performing at least a second encoding of the current picture in response to the first estimation of adaptive interpolation filter and using the motion vector and mode decisions, in an n-th iteration optimized for sub-pixel motion vectors determined in the n-th iteration, (c)(v) encoding the current picture again in a final n+1th iteration pass to create a final pass encoded representation, and (c)(vi) selecting either the first pass encoded representation or the final pass encoded representation as an optimally efficient encoded representation for the current picture, and outputting an encoded video stream of the optimally efficient encoded representation.

One embodiment of the invention is a method of optimizing encoding in a video codec, comprising: (a) performing a first pass encoding of a current picture within the plurality of pictures within the video in response to executing transforms, quantization and applying a predetermined interpolation filter optimized for sub-pixel motion vectors; (b) performing a first pass estimation of an adaptive interpolation filter optimized for pixel and sub-pixel motion vectors to create a first pass encoded representation; (c) communicating motion vectors, mode decisions and first estimation of an adaptive interpolation filter from the first pass estimation for subsequent encoding; (d) performing at least a second encoding of the current picture, in response to the first estimation of adaptive interpolation filter and using the motion vector and mode decisions, to generate a final pass encoded representation; (e) selecting either the first pass encoded representation or the final pass encoded representation as an optimally efficient encoded representation for the current picture; and (f) outputting an encoded video stream of the optimally efficient encoded representation.

The present invention provides a number of beneficial elements which can be implemented either separately or in any desired combination without departing from the present teachings.

An element of the invention is an apparatus and method for increasing encoding efficiency using fast encoding with adaptive interpolation filters.

Another element of the invention is the performing of multiple estimations of adaptive interpolation filters based on updated sub-pixel motion estimations and compensation.

Another element of the invention is a video encoding apparatus and method which performs a first encoding with predetermined interpolation filter, followed by a second encoding which receives one or more estimates from the first pass, such as estimated adaptive interpolation filter (AIF), motion vectors, mode decisions, other desired parameters, and any desired combinations thereof.

Another element of the invention is a video encoding apparatus and method which performs a first encoding with predetermined interpolation filter, followed by an iterative encoding which receives one or more estimates from the first pass, such as estimated adaptive interpolation filter (AIF), motion vectors, mode decisions, other desired parameters, and any desired combinations thereof.

Another element of the invention is determining the number of iterations to perform in achieving a desired level of optimized compression.

A still further element of the invention is that the inventive apparatus and method can be applied to a variety of video coding applications, codecs and so forth.

Further element of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic of conventional two pass estimation of an adaptive interpolation filter.

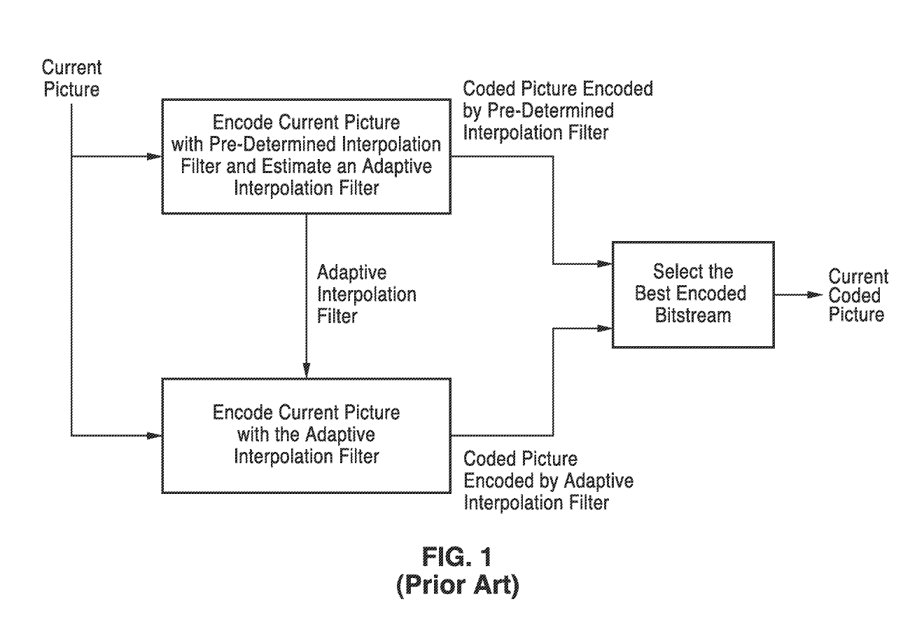

FIG. 2 is a schematic of an adaptive interpolation filter, utilized according to an element of the present invention, showing that the interpolation filter is trained on the fly.

FIG. 3 is a schematic of non-iterative fast estimation of an adaptive interpolation filter (AIF) according to an element of the present invention, showing information on mode decisions and motion vectors being passed to the second iteration.

FIG. 4 is a schematic of a fast iterative estimation of an adaptive interpolation filter (AIF) according to an element of the present invention, showing the passing of mode and motion information within AIF estimation iterations.

FIG. 5 is a schematic of an encoder embodiment according to an embodiment of the present invention.

FIG. 6 is a flow diagram of non-iterative fast estimation of an adaptive interpolation filter (AIF) according to an embodiment of the present invention.

FIG. 7 is a flow diagram of fast iterative estimation of an adaptive interpolation filter (AIF) according to an embodiment of the present invention.

### DETAILED DESCRIPTION OF THE INVENTION

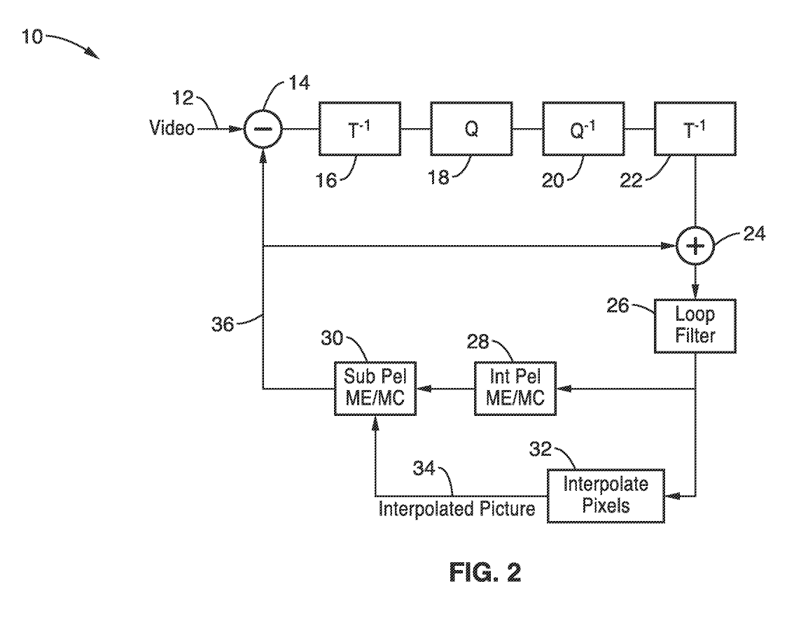

Referring more specifically to the drawings, for illustrative purposes the present invention is embodied in the apparatus generally shown in FIG. 2 through FIG. 7. It will be appreciated that the apparatus may vary as to configuration and as to details of the parts, and that the method may vary as to the specific steps and sequence, without departing from the basic concepts as disclosed herein. Furthermore, elements represented in one embodiment as taught herein are applicable without limitation to other embodiments taught herein, and combinations with those embodiments and what is known in the art.

FIG. 2 illustrates a general process 10 of estimating interpolation filters and performing motion estimation and compensation at the pixel and sub-pixel levels. This general flow is compatible with the ITU-T/KTA standard. Frames of video 12 are compared 14 with prior encoding to produce a difference signal between the original and predicted frames which is subject to execution of a transform 16, a quantization 18, an inverse quantization 20 and upon which an inverse transform 22 is executed to produce an output which is summed 24 with a prior input and received by a loop filter 26. Loop filter output is received for optimized motion estimation (ME) and motion compensation (MC) at an integer pixel (pixel level) 28, and then at the sub-pixel level 30. Pixel interpolation 32 is performed to generate an interpolated picture 34 which is used in sub-pixel ME/MC. An encoded output 36 is produced which is then compared at block 14.

1. Non-Iterative Determination of Adaptive Interpolation Filters.

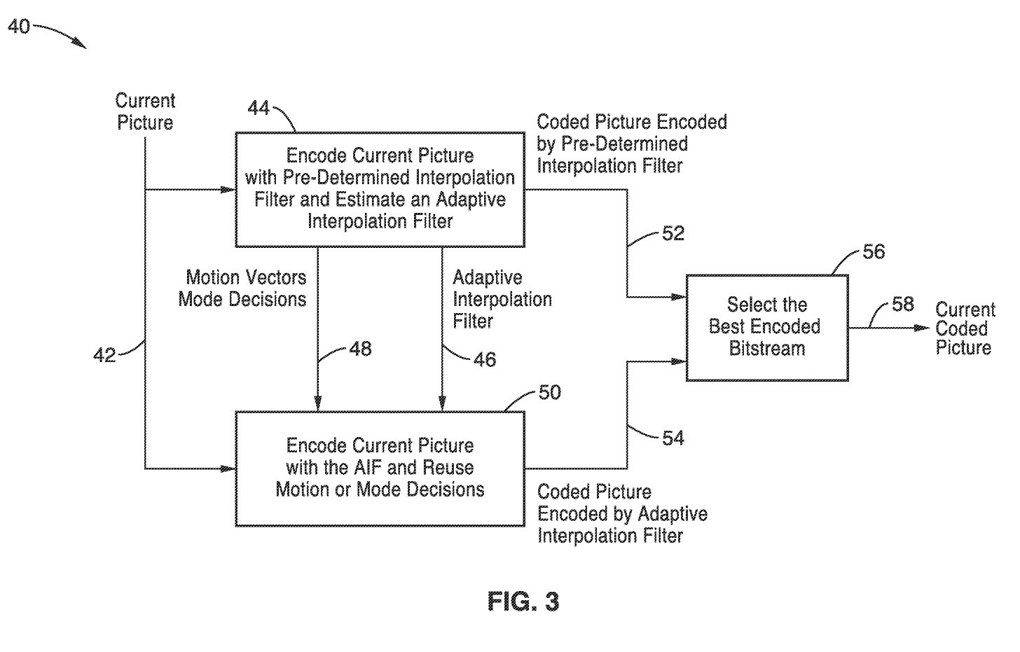

FIG. 3 illustrates an example embodiment 40 of performing a non-iterative fast estimation of AIF. The two pass nature of interpolation filter estimation is retained. Current picture 42 is received by a first pass encoding block 44 in response to a pre-determined (fixed) interpolation filter. The interpolation filter from AVC is used to compress the current picture and to estimate the optimal interpolation filter based on the current sub-pixel motion vectors. The adaptive interpolation filter (AIF) 46 estimated during encoding 44 is passed to a second pass encoding block 50.

In first pass encoding block 44, the mode decisions and motion vectors of a macroblock are determined. It should be appreciated that the mode decisions of a macroblock include whether it is intra coded or non-intra coded, as well as including the prediction mode and partition of the macroblock. To obtain the mode decisions and the corresponding motion vectors of a macroblock, encoding block 44 tests different combinations of modes and corresponding motion vectors and selects one particular mode and the corresponding motion vectors.

In this inventive embodiment, second pass encoding block 50 receives motion vectors and mode decisions 48 from the first encoding block along with receiving an estimation of the AIF. In the second pass estimated adaptive interpolation filter from the first pass is used to replace the AVC interpolation filter to compress the current picture again. In response to receiving these mode decisions and motion vectors from the first pass, encoding within the second pass block is substantially sped up by reusing the prediction mode, partition, and corresponding integer components of the motion vectors of a macroblock from the first pass to the collocated macroblock in the second pass In particular, if a macroblock is intra coded in the first pass, it shall be intra coded in the second pass. If a macroblock in the first pass is forward inter coded with a certain block partition and motion vectors, the macroblock in the second pass is also forward inter coded with the same block partition and motion vectors with the same integer components. In this case, only sub-pel motion estimation is needed to obtain the final motion vectors.

An output 52 from the first encoding pass, and an output 54 from the second encoding pass are compared 56, and either the first or second pass encoding are selected as the final coded representation 58 of the current coded picture.

2. Iterative Determination of Adaptive Interpolation Filters.

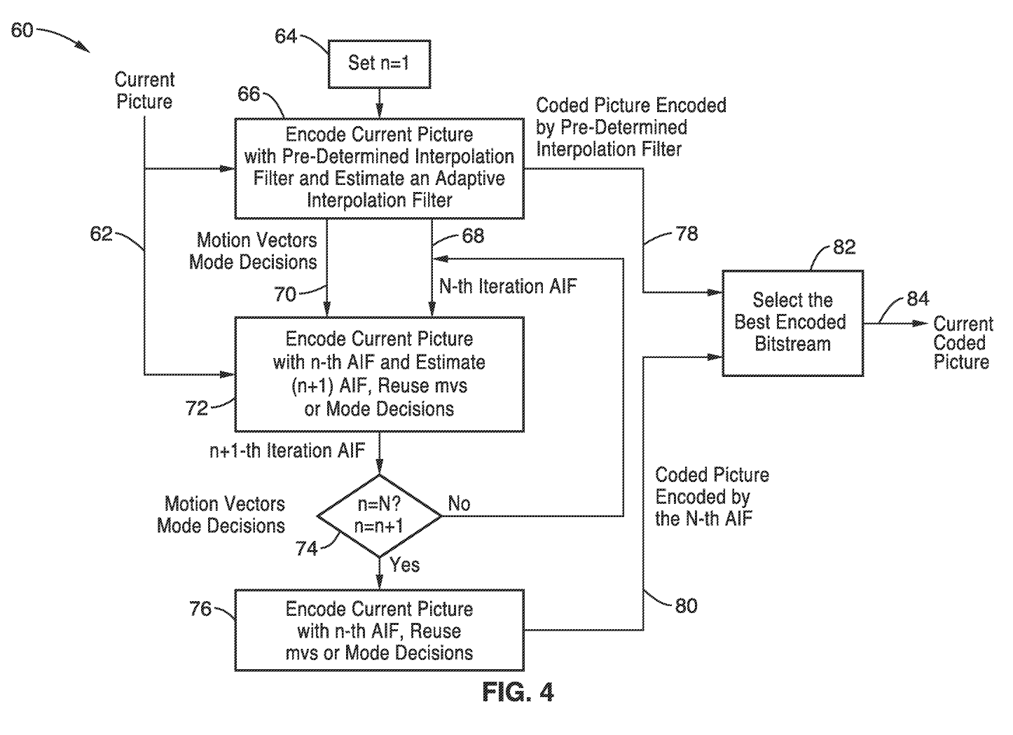

FIG. 4 illustrates an example embodiment 60 which is similar to that shown in FIG. 3, as motion vector and mode decisions are passed on to subsequent coding steps, within an iterative encoding process. Current picture 62 is received by a first pass encoding block 66 in response to a pre-determined (fixed) interpolation filter. The iteration count is shown being initialed 64, such as to n=1, prior to encoding block 66. The interpolation filter from AVC is used to compress the current picture in block 66 and to estimate the optimal interpolation filter based on the current sub-pixel motion vectors. Both the adaptive interpolation filter (AIF) 68 and the motion vectors and mode decisions 70 are passed to an iterative encoding block 72. In block 72 the current picture is encoded with the estimated AIF and another AIF is estimated. Encoding within block 72 is performed through N iterations, as shown determined by block 74.

It should be appreciated that the number of iterations performed can be in response to a predetermined value as exemplified, or in response to any desired determination that sufficient iterations have been performed. A final encoding 76 is performed using the final estimate of AIF and reusing the motion vector and mode decisions from iterative block 72. A decision 82 is then made to select either the coded picture 78 or the coded picture 80 for the current coded output 84.

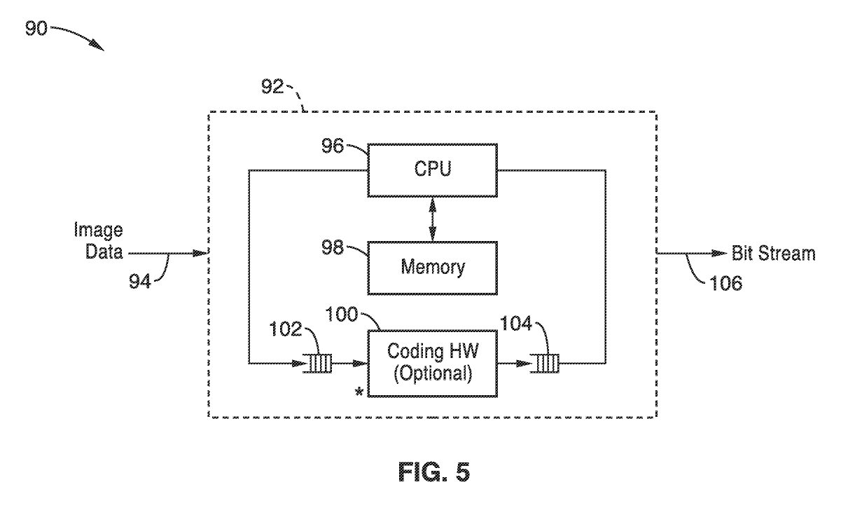

FIG. 5 illustrates an example embodiment 90 of a video encoding apparatus 92. A computer processor is shown upon which programming may be executed for carrying out the encoding steps along with optional hardware acceleration. Encoder apparatus 92 is shown receiving image data 94 which is processed by a computer processor (CPU) 96 shown coupled to a memory 98. It should be appreciated that coder apparatus 92 can comprise one or more computer processing elements, and one or more memories, each of any desired type to suit the application, either separately or used in combination with any other desired circuitry. The coded bit stream 106 is output from block 92 in response to encoding processing which includes multiple iterations of estimating interpolation filters.

It should be appreciated that a coding apparatus according to the present invention can be implemented wholly as programming executing on a computer processor, or alternatively as a computer processor executing in combination with acceleration hardware, or solely in hardware, such as logic arrays or large scale integrated circuits. By way of example, coding hardware is represented by a block 100 which receives input through a first buffer 102, with output through a second buffer 104. If coding hardware is utilized according to the present teachings, it can be utilized to perform any desired portions of the operations recited in the description, or all of the operations thereof.

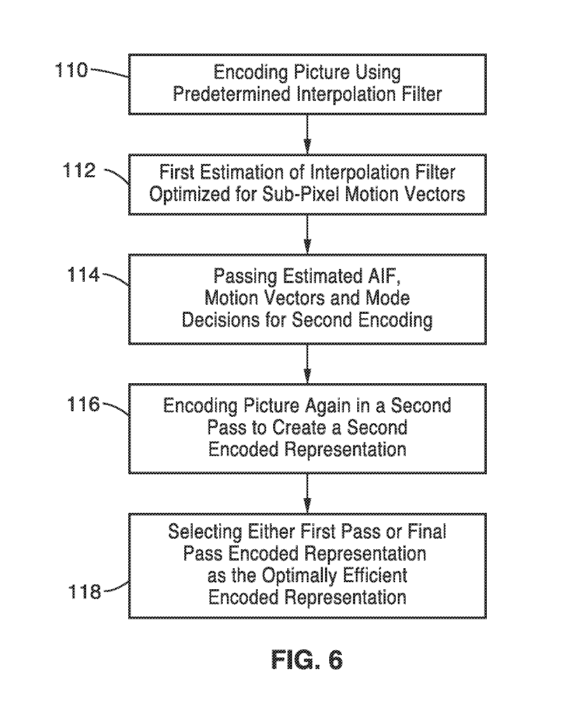

FIG. 6 illustrates general steps according to at least one example embodiment of the present invention for performing fast non-iterative encoding. Encoding 110 is performed on a picture from a video using a predetermined interpolation filter, in combination with making a first estimation 112 of interpolation filter in response to optimizing sub-pixel motion vectors. Information is passed 114 from the first encoding block to a second level of encoding 116 which uses the motion vectors and mode decisions passed from the first encoding block to generate an encoded representation. Then a process of selecting 118 is performed to select either the first pass or the final pass as the final encoded representation of the current picture. The selection is performed in response to determining which of the two encoded outputs is the more optimally encoded with the least amount of rate-distortion cost. The rate-distortion cost of an encoded output is defined as R+λD where R is the bit count of the compressed output, D is the distortion of the picture, and λ is a function of the average of the quantization parameter of the macroblocks in the picture.

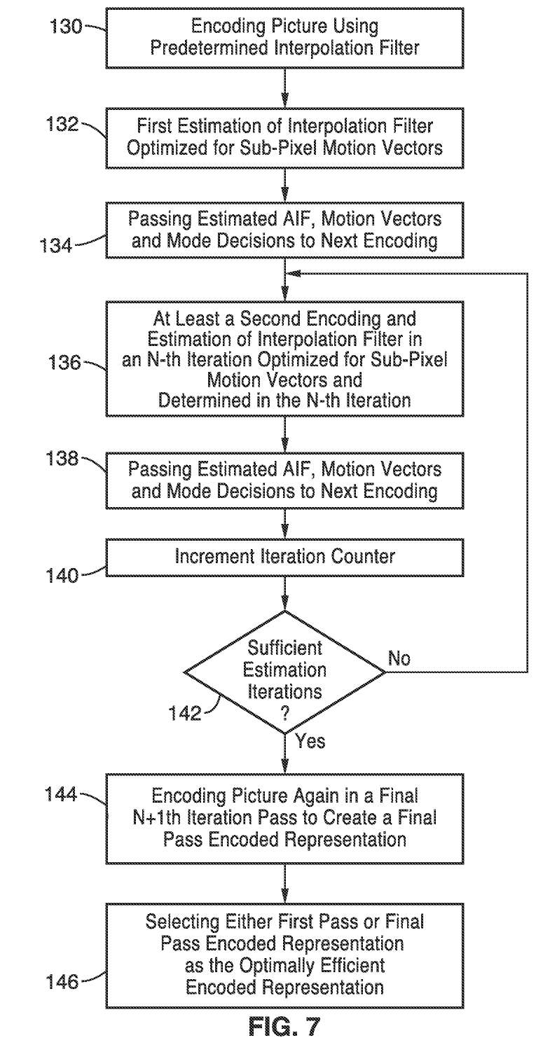

FIG. 7 illustrates general steps according to at least one example embodiment of the present invention for performing fast iterative encoding. Encoding 130 is performed on a picture from a video using a predetermined interpolation filter in combination with a first 132 estimation of interpolation filter in response to optimizing sub-pixel motion vectors. Information on estimated AIF and motion vectors are passed 134 from the first encoding block to an iterative estimation section 136, in which encoding and estimation is performed. Information is then passed 138 on estimated AIF and motion vectors from the second encoding block to an iteration control, which is shown by way of example as incrementing 140 an iteration count and checking for sufficient iterations 142. It should be appreciated that any desired mechanism can be utilized for control the number of iterations, such as using a predetermined number of passes as depicted, varying the number of passes based on the application and/or characteristics of the coding being performed, terminating iterations in response to a lack of change detected between iterations, or any desired metric or combination of metrics. If insufficient iterations have been performed, then another encoding and estimation is performed 136, otherwise a final encoding step 144 using the estimated AIF from the last iteration and reusing the motion vectors and mode decisions. The final representation of the picture is then selected 146 in response to determining which output is the most optimally encoded with the least amount of rate-distortion cost.

From the foregoing, it will be appreciated that the present invention provides various methods and apparatus for video encoding. The inventive teachings can be applied in a variety of apparatus and applications, including various codecs and similar apparatus. The present invention can be embodied in various ways, which include but are not limited to the following:

1. An apparatus for optimizing encoding in a video codec, comprising:

a computer configured for receiving a video having a plurality of pictures; a memory coupled to said computer; and programming configured for retention in said memory and executable on said computer for, performing a first pass encoding of a current picture within said plurality of pictures within said video in response to executing transforms, quantization and applying a predetermined interpolation filter optimized for sub-pixel motion vectors, performing a first pass estimation of an adaptive interpolation filter optimized for pixel and sub-pixel motion vectors to create a first pass encoded representation, communicating motion vectors, mode decisions and first estimation of an adaptive interpolation filter from said first pass estimation for subsequent encoding, performing at least a second encoding of the current picture, in response to said first estimation of adaptive interpolation filter and using the motion vector and mode decisions, to generate a final pass encoded representation, selecting either the first pass encoded representation or the final pass encoded representation as an optimally efficient encoded representation for the current picture, and outputting an encoded video stream of the optimally efficient encoded representation.

2. The apparatus of embodiment 1, wherein said encoding comprises a transform, a quantization, an inverse quantization, and an inverse transform.

3. The apparatus of embodiment 1, wherein each said estimation of an interpolation filter is defined in response to a set of filter coefficients.

4. The apparatus of embodiment 3, further comprising programming executable on said computer for compressing and embedding said set of filter coefficients within said encoded video stream.

5. The apparatus of embodiment 1, wherein motion vectors and mode decisions are generated from the first pass encoding.

6. The apparatus of embodiment 1, wherein said apparatus is configured for dynamically changing the interpolation filter on a picture-by-picture basis as the video is encoded.

7. The apparatus of embodiment 1, further comprising programming executable on said computer for: performing iterative encoding and estimation of interpolation filter in an n-th iteration optimized for sub-pixel motion vectors determined in said n-th iteration within said at least a second encoding; and wherein said final pass encoded representation is generated in response to an n+1th iteration pass.

8. The apparatus of embodiment 7, further comprising programming executable on said computer for determining if said n-th iteration is the last iteration prior to encoding the current picture again.

9. An apparatus of embodiment 7, wherein n of said n-th iteration is compared against a threshold value N to determine if said n-th iteration is the last iteration prior to encoding the current picture again.

10. An apparatus for optimizing encoding in a video codec, comprising: a computer configured for receiving a video having a plurality of pictures; a memory coupled to said computer; and programming configured for retention in said memory and executable on said computer for, performing a first pass encoding of a current picture within said plurality of pictures within said video in response to executing transforms, quantization and applying a predetermined interpolation filter optimized for sub-pixel motion vectors, performing a first estimation of an adaptive interpolation filter optimized for pixel and sub-pixel motion vectors to create a first pass encoded representation, communicating motion vectors, mode decisions and first estimation of an adaptive interpolation filter from said first pass estimation for subsequent encoding, performing at least a second encoding of the current picture in response to said first estimation of adaptive interpolation filter and using the motion vector and mode decisions, in an n-th iteration optimized for sub-pixel motion vectors determined in said n-th iteration, encoding the current picture again in a final n+1th iteration pass to create a final pass encoded representation, and selecting either the first pass encoded representation or the final pass encoded representation as an optimally efficient encoded representation for the current picture, and outputting an encoded video stream of the optimally efficient encoded representation.

11. The apparatus of embodiment 10, wherein said encoding comprises a transform, a quantization, an inverse quantization, and an inverse transform.

12. The apparatus of embodiment 10, wherein each said estimation of an interpolation filter is defined in response to a set of filter coefficients.

13. The apparatus of embodiment 10, further comprising programming executable on said computer for compressing and embedding said set of filter coefficients within said encoded video stream.

14. The apparatus of embodiment 10, wherein motion vectors and mode decisions are generated from the first pass encoding.

15. The apparatus of embodiment 10, wherein said apparatus is configured for dynamically changing the interpolation filter on a picture-by-picture basis as the video is encoded.

16. A method of optimizing encoding in a video codec, comprising: performing a first pass encoding of a current picture within said plurality of pictures within said video in response to executing transforms, quantization and applying a predetermined interpolation filter optimized for sub-pixel motion vectors; performing a first pass estimation of an adaptive interpolation filter optimized for pixel and sub-pixel motion vectors to create a first pass encoded representation; communicating motion vectors, mode decisions and first estimation of an adaptive interpolation filter from said first pass estimation for subsequent encoding; performing at least a second encoding of the current picture, in response to said first estimation of adaptive interpolation filter and using the motion vector and mode decisions, to generate a final pass encoded representation; selecting either the first pass encoded representation or the final pass encoded representation as an optimally efficient encoded representation for the current picture; and outputting an encoded video stream of the optimally efficient encoded representation.

17. The method of embodiment 16, further comprising: performing iterative encoding and estimation of interpolation filter in an n-th iteration optimized for sub-pixel motion vectors determined in said n-th iteration within said at least a second encoding; and wherein said final pass encoded representation is generated in response to an n+1th iteration pass.

18. The method of embodiment 17, further comprising determining if said n-th iteration is the last iteration prior to encoding the current picture again.

19. The method of embodiment 17, wherein n of said n-th iteration is compared against a threshold value N to determine if said n-th iteration is the last iteration prior to encoding the current picture again.

20. The method of embodiment 16, further comprising compressing and embedding said set of filter coefficients within said encoded video stream.

Embodiments of the present invention are described with reference to flowchart illustrations of methods and systems according to embodiments of the invention. It will be appreciated that elements of any “embodiment” recited in the singular, are applicable according to the inventive teachings to all inventive embodiments, whether recited explicitly, or which are inherent in view of the inventive teachings herein. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for optimizing encoding in a video codec, comprising:
(a) a computer configured for receiving a video having a plurality of pictures;
(b) a memory coupled to said computer; and
(c) programming configured for retention in said memory and executable on said computer for,
(i) performing a first pass encoding of a current picture within said plurality of pictures within said video in response to executing transforms, quantization and applying a predetermined interpolation filter optimized for sub-pixel motion vectors,
(ii) performing a first pass estimation of an adaptive interpolation filter optimized for pixel and sub-pixel motion vectors to create a first pass encoded representation,
(iii) communicating motion vectors, mode decisions and first estimation of an adaptive interpolation filter from said first pass estimation for subsequent encoding,
(iv) performing at least a second encoding of the current picture, in response to said first estimation of adaptive interpolation filter and using the motion vector and mode decisions, to generate a final pass encoded representation,
(v) selecting either the first pass encoded representation or the final pass encoded representation as an optimally efficient encoded representation for the current picture, and
(vi) outputting an encoded video stream of the optimally efficient encoded representation.

2. The apparatus recited in claim 1, wherein said encoding comprises a transform, a quantization, an inverse quantization, and an inverse transform.

3. The apparatus recited in claim 1, wherein each said estimation of an interpolation filter is defined in response to a set of filter coefficients.

4. The apparatus recited in claim 3, further comprising programming executable on said computer for compressing and embedding said set of filter coefficients within said encoded video stream.

5. The apparatus recited in claim 1, wherein motion vectors and mode decisions are generated from the first pass encoding.

6. The apparatus recited in claim 1, wherein said apparatus is configured for dynamically changing the interpolation filter on a picture-by-picture basis as the video is encoded.

7. The apparatus recited in claim 1, further comprising programming executable on said computer for:
performing iterative encoding and estimation of interpolation filter in an n-th iteration optimized for sub-pixel motion vectors determined in said n-th iteration within said at least a second encoding; and
wherein said final pass encoded representation is generated in response to an n+1th iteration pass.

8. The apparatus recited in claim 7, further comprising programming executable on said computer for determining if said n-th iteration is the last iteration prior to encoding the current picture again.

9. An apparatus recited in claim 7, wherein n of said n-th iteration is compared against a threshold value N to determine if said n-th iteration is the last iteration prior to encoding the current picture again.

10. An apparatus for optimizing encoding in a video codec, comprising:
(a) a computer configured for receiving a video having a plurality of pictures;
(b) a memory coupled to said computer; and
(c) programming configured for retention in said memory and executable on said computer for,
(i) performing a first pass encoding of a current picture within said plurality of pictures within said video in response to executing transforms, quantization and applying a predetermined interpolation filter optimized for sub-pixel motion vectors,
(ii) performing a first estimation of an adaptive interpolation filter optimized for pixel and sub-pixel motion vectors to create a first pass encoded representation,
(iii) communicating motion vectors, mode decisions and first estimation of an adaptive interpolation filter from said first pass estimation for subsequent encoding,
(iv) performing at least a second encoding of the current picture in response to said first estimation of adaptive interpolation filter and using the motion vector and mode decisions, in an n-th iteration optimized for sub-pixel motion vectors determined in said n-th iteration,
(v) encoding the current picture again in a final n+1th iteration pass to create a final pass encoded representation, and
(vi) selecting either the first pass encoded representation or the final pass encoded representation as an optimally efficient encoded representation for the current picture, and
(vii) outputting an encoded video stream of the optimally efficient encoded representation.

11. The apparatus recited in claim 10, wherein said encoding comprises a transform, a quantization, an inverse quantization, and an inverse transform.

12. The apparatus recited in claim 10, wherein each said estimation of an interpolation filter is defined in response to a set of filter coefficients.

13. The apparatus recited in claim 10, further comprising programming executable on said computer for compressing and embedding said set of filter coefficients within said encoded video stream.

14. The apparatus recited in claim 10, wherein motion vectors and mode decisions are generated from the first pass encoding.

15. The apparatus recited in claim 10, wherein said apparatus is configured for dynamically changing the interpolation filter on a picture-by-picture basis as the video is encoded.

16. A method of optimizing encoding in a video codec, comprising:
performing a first pass encoding of a current picture within said plurality of pictures within said video in response to executing transforms, quantization and applying a predetermined interpolation filter optimized for sub-pixel motion vectors;
performing a first pass estimation of an adaptive interpolation filter optimized for pixel and sub-pixel motion vectors to create a first pass encoded representation;
communicating motion vectors, mode decisions and first estimation of an adaptive interpolation filter from said first pass estimation for subsequent encoding;
performing at least a second encoding of the current picture, in response to said first estimation of adaptive interpolation filter and using the motion vector and mode decisions, to generate a final pass encoded representation;
selecting either the first pass encoded representation or the final pass encoded representation as an optimally efficient encoded representation for the current picture; and
outputting an encoded video stream of the optimally efficient encoded representation.

17. The method recited in claim 16, further comprising:
performing iterative encoding and estimation of interpolation filter in an n-th iteration optimized for sub-pixel motion vectors determined in said n-th iteration within said at least a second encoding; and
wherein said final pass encoded representation is generated in response to an n+1th iteration pass.

18. The method recited in claim 17, further comprising determining if said n-th iteration is the last iteration prior to encoding the current picture again.

19. The method recited in claim 17, wherein n of said n-th iteration is compared against a threshold value N to determine if said n-th iteration is the last iteration prior to encoding the current picture again.

20. The method recited in claim 16, further comprising compressing and embedding said set of filter coefficients within said encoded video stream.
